(19) United States
(12) Patent Application Publication
(10) Pub. No.: US 2006/0279405 A1
(43) Pub. Date: Dec. 14, 2006

(54) Wireless system for alerting hearing-impaired person

(76) Inventor: Randall T. Erickson, Wheaton, IL (US)

Correspondence Address: THE LAW OFFICE OF RANDALL T. ERICKSON, P.C., 425 WEST WESLEY STREET, SUITE 1, WHEATON, IL, 60187, US

(21) Appl. No.: 11/435,552

(22) Filed: May 17, 2006

Related U.S. Application Data
(60) Provisional application No. 60/681,614, filed on May 17, 2005.

(51) Int. Cl. G08B 5/22

(52) U.S. Cl. 340/7.61; 340/815.4; 340/7.62

(57) ABSTRACT

A wireless annunciator system useful in attracting the attention of a hearing deprived person within a dwelling, such as a person wearing headphones, includes a sending unit advantageously located on a ground floor living area of the dwelling and a receiving unit advantageously located in a room occupied by the hearing deprived person. The sending unit includes a call button and a wireless transmitter and the receiving unit includes a wireless receiver and a LED lamp. When the sending unit call button is pushed the receiving unit illuminates the LED lamp to alert the hearing deprived person.

This application claims the benefit of Provisional Application U.S. Ser. No. 60/681,614, filed May 17, 2005.

### BACKGROUND OF THE INVENTION

A common occurrence in many homes is the situation where a teenage person of the family is located on a second-floor or on a basement floor of a multi-floor dwelling listening to loud music either through loudspeakers or through headphones. If this teenage person of the family needs to be summoned for dinner or to answer the telephone, since the teenage person cannot be reached through an audible shout from the teenage person's parent, the parent must either climb the stairs to knock loudly on the teenage person's door or descend the stairs to confront the teenage on the level below. In either case the physical exertion of ascending or descending the stairs to summon the teenage person is an aggravation to the parent.

The present inventor has recognized that it would be beneficial to provide a system for contacting the otherwise audibly inaccessible teenage person and alleviating the burden of the parent ascending or descending stairs to reach and contact the teenage person.

### SUMMARY OF THE INVENTION

The invention provides a wireless system for alerting a teenager or other hearing deprived person within a dwelling who cannot be reached by an audible call or shout. The invention provides a wireless system for alerting a teenager who cannot be reached by an audible call or shout that is inexpensively manufactured, easily installed in the dwelling, and effective for its purpose.

Although the present invention is particularly advantageous to summon a teenager listening to loud music, it is also effective to summon any other hearing deprived person, whether that person is listening to loud music or is hearing-impaired.

The preferred embodiment of the present invention includes a sending unit that would typically be located on the ground floor of a dwelling, such as in the kitchen. The sending unit would include a call button, a sending unit power supply, and a transmitter. The transmitter would include an antenna to wireless transmit a call signal for a relatively short distance, such as from between the kitchen and an upstairs bedroom. A receiving unit would be mounted in the receiving location such as in the upstairs bedroom. The receiving unit would include a receiving antenna that is operatively connected to a control. The control is powered by a receiving unit power supply. The control controls a annunciator lamp. The annunciator lamp can be an LED type lamp that is easily sensed when turned on. The controller can also control an audible annunciator such as a buzzer, siren, or speaker that emits an audible signal, supplementary to the annunciator lamp.

The sending unit and receiving unit can be provided with hook and loop (VELCRO) attachments for temporarily attaching the sending unit to a downstairs wall and the receiving unit to a wall in the upstairs bedroom.

As an enhancement to the invention, the sending unit can include multiple call buttons, each call button coded by its purpose. For example, a first call button could be for announcing to the teenager that he or she is wanted on the telephone, the second call button could be for announcing to the teenager that he or she is instructed to come downstairs for dinner, etc. A corresponding annunciator lamp for each purpose could be provided on the receiving unit. The sending unit would issue a corresponding wireless call signal for each call button and the sending unit would illuminate the corresponding annunciator lamp.

As another enhancement of the invention two or more call buttons can be configured with the transmitter unit of the sending unit to issue different wireless signals to different receiving units to cause the respective annunciators of those units to operate. Thus, a single sending unit can be selectively used to summon persons in different rooms of the dwelling. This is particularly advantageous when more than one teenager lives in the dwelling.

The invention is particularly advantageous in that it is compact, inexpensively manufactured, easily removed when no longer desired and effectively utilized.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a schematic view of the system of the present invention in a dwelling;

FIG. 2 is a schematic system view of the system shown in FIG. 1; and

FIG. 3 is a schematic view of an alternate embodiment system.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

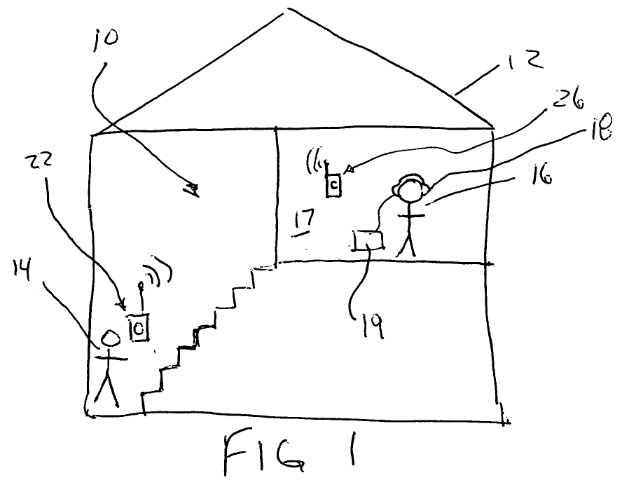

FIG. 1 illustrates in schematic form a typical household. The system 10 according to the invention is mounted within a dwelling 12. In the dwelling 12, a parent 14 is located on a ground floor. A teenager 16 is located some distance away in a bedroom 17 on an elevated second-floor. The teenager 16 is wearing headphones 18 which are supplied with loud music from a stereo or other type music player 19. It was heretofore known that if the teenager 16 received a telephone call, was needed to come downstairs for dinner, or received a visitor at the door, that the parent 14, despite repeated shouts, would be required to climb the stairs to the second-floor and bang loudly on the door to summon the teenager, who could then to receive instructions once the headphones were removed.

According to the system of the invention, a sending unit 22 is conveniently mounted on the ground floor of the dwelling, such as in a front hallway, or in the kitchen, or other easily accessible place. A receiving unit 26 is mounted within the teenager's bedroom 17, preferably on the wall in a visually attention-getting location.

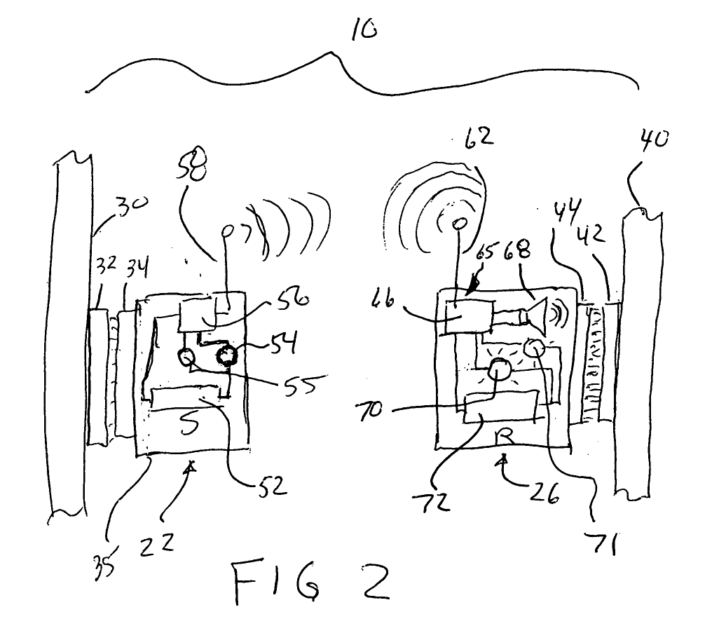

FIG. 2 illustrates in schematic form the system 10. The sending unit 22 is mounted onto a wall 30 by a strip of hook and loop (VELCRO) tape 32 that is adhesively secured to the wall and a strip of mating hook and loop (VELCRO) tape 34 that is adhesively secured to a body 35 of the sending unit 22. The receiving unit 26 is mounted in similar fashion to an upstairs wall 40 using similar hook and loop (VELCRO) strips 42, 44. The hook and loop (VELCRO) strip 42 is adhesively secured to the wall 40. The mating hook and loop (VELCRO) strip 44 is adhesively secured to the receiving unit 26.

The sending unit 22 includes a sending unit power supply, such as provided by a battery 52, one or more call buttons 54, 55 and an electronic transmitter 56 connected to a transmitting antenna 58. The transmitter 56 preferably issues a RF signal.

The receiving unit includes a wireless signal receiver 65, optionally one or more audible annunciators 68 (one shown), one or more annunciator lamps 70, 71, and a power supply such as a battery 72. The receiver 65 can include a control unit 66 that is connected to a receiving antenna 62.

In operation, when the parent needs to summon the otherwise audibly-inaccessible teenager 18, a call button 54 or 55 is pushed by the parent, which causes thy transmitter 56 to issue a wireless signal from the antenna 58. The receiving antenna 62 receives the signal and the control unit 66, having a switching function therein, causes one or more annunciator lamps 70, 71 to illuminate, either in a flashing manner or a steady manner to alert the teenager. Preferably, the annunciator lamps 70, 71 are LED lights which radiator bright light and are more likely to get the teenager's attention.

The call buttons 54, 55 can be labeled for the category of communication from the parent, such as “answer the phone” or “come to dinner”, etc. Although two call buttons and two lamps are shown, it is encompassed by the invention that only one general call button and one annunciator lamp be used, or that more than two call buttons and lamps be used.

The receiving unit 26 can also include one or more audible annunciators 68 which could be buzzers, sirens, speakers, etc. that issue an audible signal to alert the teenager. It is possible that the audible annunciators 68 could issue a different audible tone depending on the nature of the parental message.

It is also possible that the one or more lamps 70, 71 could differentiate the category of message from the parent by a flashing code, different color lights or other difference in appearance.

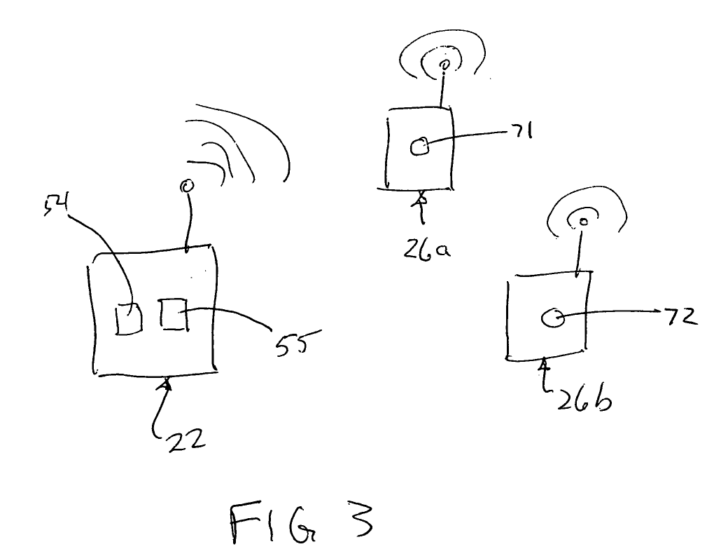

A further enhancement of the invention could be that the call buttons 54, 50 could be allocated to annunciator lamps 71, 72, and optionally audible annunciators (not shown) located on two different receiving units 26a, 26b as illustrated in FIG. 3. The transmitter 56 within the sending unit 22 could be configured to transmit a different signal upon activation of the respective buttons 54, 55, wherein the corresponding signal would be received by the corresponding receiving unit 26a, 26b. Two or more call buttons corresponding to two or more receiving units could be employed. Thus, the invention is particularly advantageous for families having two or more teenagers, wherein the selected teenager could be summoned by a parent pushing the corresponding call button.

The wireless signal issued by the sending unit and received by the receiver unit could be selected from a number of known systems, such as those used for wireless computer networks (LAN) or the systems used for garage door openers. Preferably, the signal is a selected RF signal frequency, such as used in garage door openers. Other wireless signals, of any frequency including infrared, microwave, ultrasonic, sound waves, are also encompassed by the invention.

A description of transmitters and receivers for garage door openers, which description can be modified for use in the practice of the present invention, can be found in U.S. Pat. No. 5,990,828, herein incorporated by reference. The security features, such as special codes, rolling codes and encryption, and those features particular to operation of the garage door, would probably not be needed to practice the present invention.

According to the invention the sending unit 22 and the receiving unit 26 are small, lightweight units having plastic surrounding casings. Although the units are shown as battery powered, other power supplies, such as wiring from the dwelling electric supply are also encompassed by the invention.

From the foregoing, it will be observed that numerous variations and modifications may be effected without departing from the spirit and scope of the invention. It is to be understood that no limitation with respect to the specific apparatus illustrated herein is intended or should be inferred

The invention claimed is:

1. A wireless annunciator for alerting a hearing deprived person, in a dwelling, comprising:
a sending unit having a sending unit power supply, a wireless transmitter for issuing a wireless call signal, and at least one call button, said call button selectively directing power from said sending unit power supply to said wireless transmitter to issue said wireless call signal;
a receiving unit having a receiving unit power supply, a wireless receiver for receiving said wireless call signal, and at least one lamp, said lamp selectively illuminated by said receiving unit power supply by direction of said wireless receiver when said wireless call signal is received.

2. The annunciator according to claim 1, wherein said sending unit power supply comprises a battery.

3. The annunciator according to claim 2, wherein said receiving unit power supply comprises a battery.

4. The annunciator according to claim 1, wherein said receiving unit power supply comprises a battery.

5. The annunciator according to claim 1, wherein said at least one call button comprises a first call button and a second call button, and said at least one lamp comprises a first lamp and a second lamp, said first call button wired to cause said transmitter unit to issue a first wireless call signal, said second call button wired to cause said transmitter unit to issue a second wireless call signal, said receiver unit receiving said first call signal to illuminate said first lamp and said second call signal to illuminate said second lamp.

6. The annunciator according to claim 5, wherein said receiver unit further comprising an audible annunciator, said audible annunciator issuing different audible signals for said first and second wireless call signals.

7. The annunciator according to claim 1, wherein said receiver unit further comprises an audible annunciator, said audible annunciator issuing an audible signal upon receipt by said receiver of said wireless call signal.

8. The annunciator according to claim one wherein said sending unit comprises a lightweight plastic case, and said receiving unit comprises a lightweight plastic case, and further comprising adhesive means to secure the receiving unit and adhesive means to secure the sending unit both to walls of the dwelling.

9. The annunciator according to claim 8, wherein each said adhesive means comprise a first hook and loop strip adhesively secured to a dwelling wall and a second, mating hook and loop strip adhesively secured to each said plastic case.

10. The annunciator according to claim 1, further comprising an additional receiving unit having a receiving unit power supply, a wireless receiver for receiving said wireless call signal, and at least one lamp, said lamp selectively illuminated by said receiver unit power supply by direction of said wireless receiver when said wireless call signal is received; and
wherein said sending unit includes a first call button and a second call button, and said wireless transmitter being configured to issue a selected wireless call signal corresponding to the activation of the first or second call button, said first call button selectively directing power from said sending unit power supply to said wireless transmitter to issue a selected wireless call signal to said receiving unit, and said second call button selectively directing power from said sending unit power supply to issue a selected wireless call signal to said additional receiving unit.
